(19) United States
(12) Patent Application Publication
(10) Pub. No.: US 2012/0113236 A1
(43) Pub. Date: May 10, 2012

(54) Portable Auto-Stereoscopic Media Displaying and Recording Device

(76) Inventor: Matthew JOYNES, Agoura Hills, CA (US)

(21) Appl. No.: 13/288,775

(22) Filed: Nov. 3, 2011

Related U.S. Application Data
(60) Provisional application No. 61/412,177, filed on Nov. 10, 2010.

(51) Int. Cl. H04N 13/04

(52) U.S. Cl. 348/51; 348/E13.026

(57) ABSTRACT

The present invention is a portable auto-stereoscopic media displaying and recording device. An auto-stereoscopic display screen allows a user to view stereoscopic electronic media without the need for specialized glasses. The user is able to create stereoscopic electronic media with the present invention through a 3D ASIC camera. The present invention also retrieves stereoscopic electronic media to display from a flash memory card through from a flash memory card slot, a USB enabled device through a USB port, or from the internet through an internet connectivity module. The casing, which creates a portable enclosure for the other components of the present invention, consists of two parts, a front portion and a back portion. A chipset allows the present invention to properly perform all of its functions such as executing the necessary software to display, manage, and create the files of stereoscopic electronic media.

The current application claims a priority to the U.S. Provisional Patent application Ser. No. 61/412,177 filed on Nov. 10, 2010.

### FIELD OF THE INVENTION

The present invention generally relates to an portable electronic media player, which is able to display stereoscopic images without the need to for three dimensional glasses and is able to interact with the user through a stereoscopic image captured by the device.

### BACKGROUND OF THE INVENTION

Currently, stereoscopic media players required specialized glasses to view stereoscopic electronic media such as three dimensional (3D) movies and pictures. The specialized glasses allow the left eye and the right eye to view the same image from two different angles, which creates a stereoscopic image from the user's perspective. The specialized glasses hinder the portability of traditional stereoscopic media players because the user must always carry the specialized glasses to view stereoscopic electronic media. The present invention implements an auto-stereoscopic display screen, which is able to create a stereoscopic image without the need for specialized glasses. Additionally, the present invention provides the user with a 3D camera in order to create stereoscopic electronic media. The 3D camera is used to take and/or make 3D images and content, which then allows the present invention to display and to automate the stereoscopic image with stereo digital media by inserting the stereoscopic image into pre-created environments.

### BRIEF DESCRIPTION OF THE DRAWINGS

FIG. 1 is a perspective view of the present invention in a supine position.

FIG. 2 is a top view of the present invention.

FIG. 3 is a perspective view of the present invention in an upright position.

FIG. 4 is a side view of the present invention.

FIG. 5 is a schematic of the present invention's electronic components.

### DETAIL DESCRIPTIONS OF THE INVENTION

All illustrations of the drawings are for the purpose of describing selected versions of the present invention and are not intended to limit the scope of the present invention.

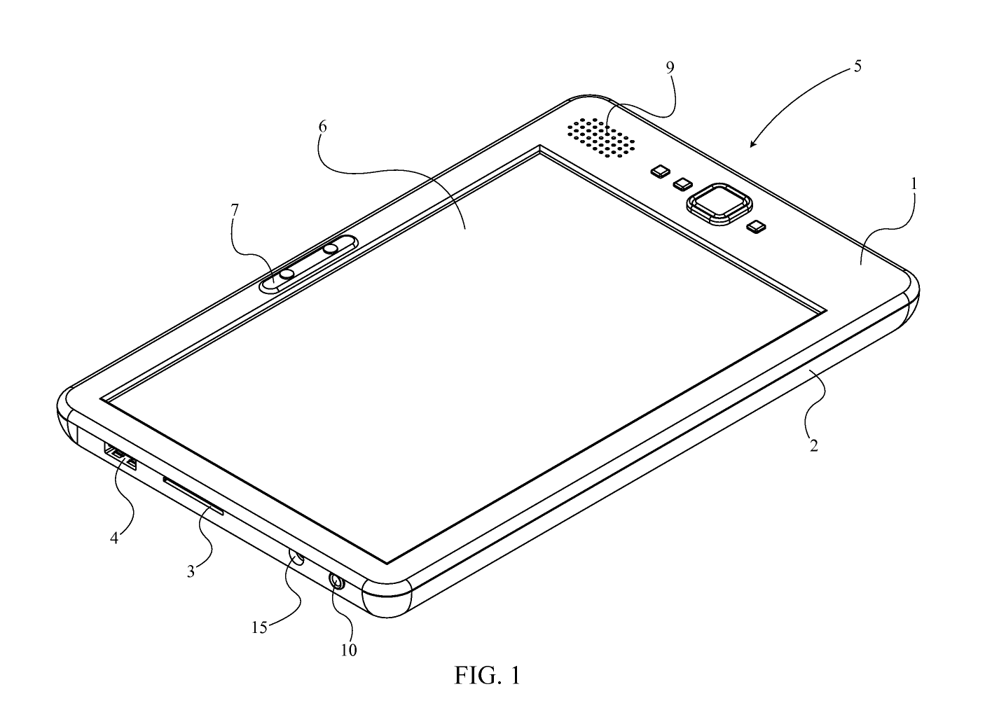

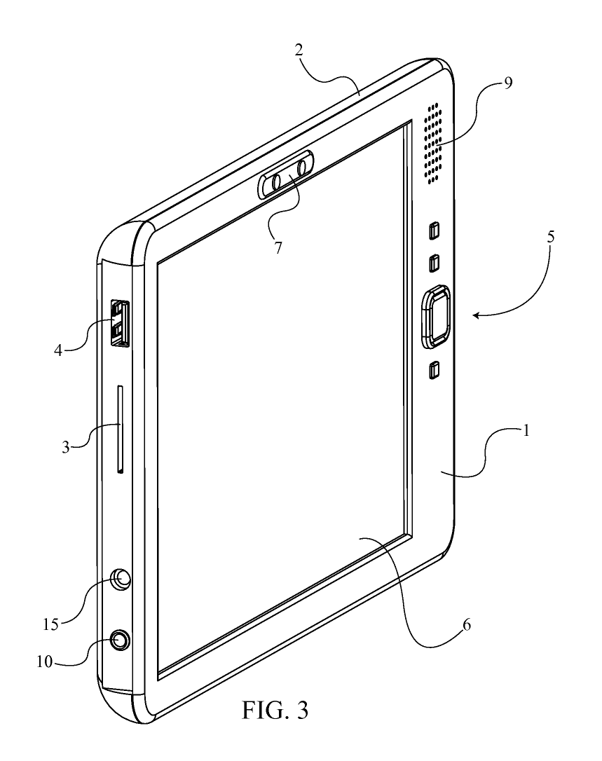

As can be seen in FIGS. 1 and 3, the present invention is a portable auto-stereoscopic media displaying and recording device, which allows a user to view and produce stereoscopic electronic media with a portable apparatus. The primary components of the present invention include a frame casing 1, a base casing 2, a control panel 5, an auto-stereoscopic display screen 6, a three-dimensional application specific integrated circuit camera 7 (3D ASIC camera), a speaker 9, and a headphone jack 10. The auto-stereoscopic display screen 6 allows the user to view the visual portion of the stereoscopic electronic media without the use of specialized glasses, which are usually used to view three-dimensional images. In the preferred embodiment of the present invention, the auto-stereoscopic display screen 6 is a digital eight inch liquid crystal display that presents the stereoscopic electronic media in 1280 by 768 high definition pixels. The speaker 9 and the headphone jack 10 allows the user to listen to the audio portion of the stereoscopic electronic media. In the preferred embodiment, the headphone jack 10 has the standard diameter of 3.5 millimeters. The 3D ASIC camera 7 is used as the means to record stereoscopic electronic media such as videos and pictures. The control panel 5 allows the user to access the software that organizes and manages the stereoscopic electronic media shown on the present invention. In the preferred embodiment, the control panel has at least an on/off switch to activate and deactivate the present invention, a switch to change the auto-stereoscopic display screen in between 2D mode and 3D mode, a pad to activate different media functions, and a button to activate the menu feature. The frame casing 1 and the base casing 2 provide the other components of the present invention an enclosure to be situated within. In the preferred embodiment, the combination of the frame casing 1 and the base casing 2 form a tablet-shaped enclosure.

The components that provide the present invention with stereoscopic electronic media are an internet connectivity module 8, a flash memory card slot 3, and an universal serial bus port 4 (USB port). The internet connectivity module 8 allows the present invention to display stereoscopic electronic media from the internet. In the preferred embodiment of the present invention, the internet connectivity module 8 allows the present invention to connect to the internet via Wi-Fi and allows the present invention to access an online web portal, which provides the user with different kinds of 3D content such as instructional and educational videos. The flash memory card slot 3 allows the present invention to display stereoscopic electronic media on a flash memory digital data storage device. For example, the flash memory card slot 3 would allows the present invention to access stereoscopic electronic media on an SD card or a micro SD card. The USB port 4 allows the present invention to display stereoscopic electronic media on USB accessible electronic devices such as a flash drive or an external hard drive. In the preferred embodiment, the present invention would also comprises a plurality of electronic storages devices, which could be accessed through the flash memory card slot 3 or the USB port 4. The plurality of electronic storages devices would come preloaded with stereoscopic electronic media such as instructional and educational videos.

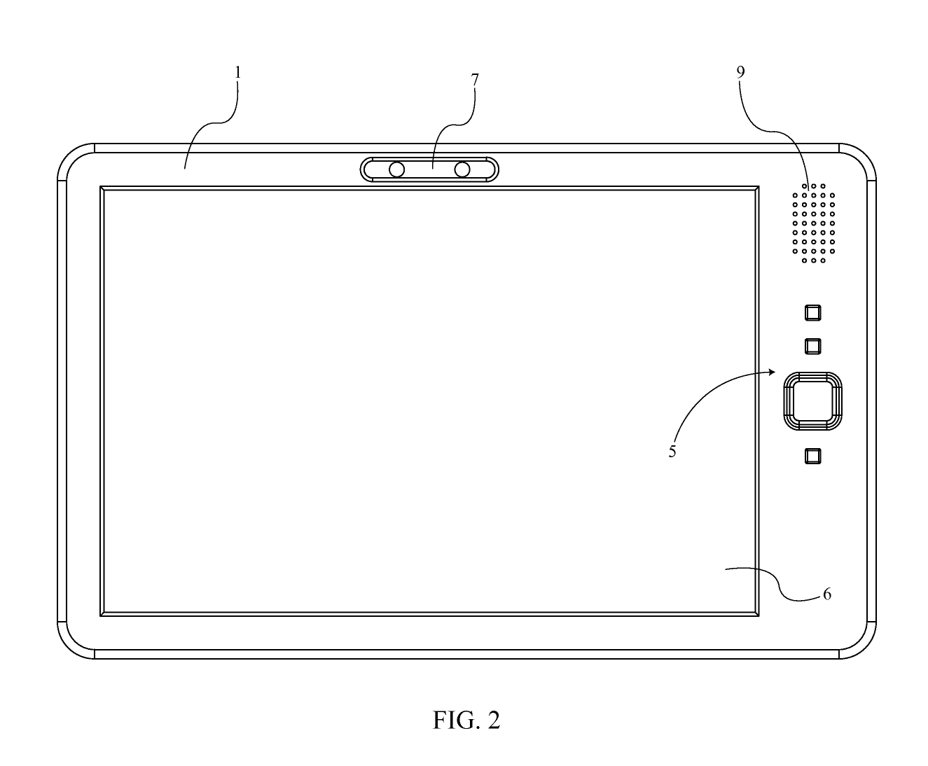

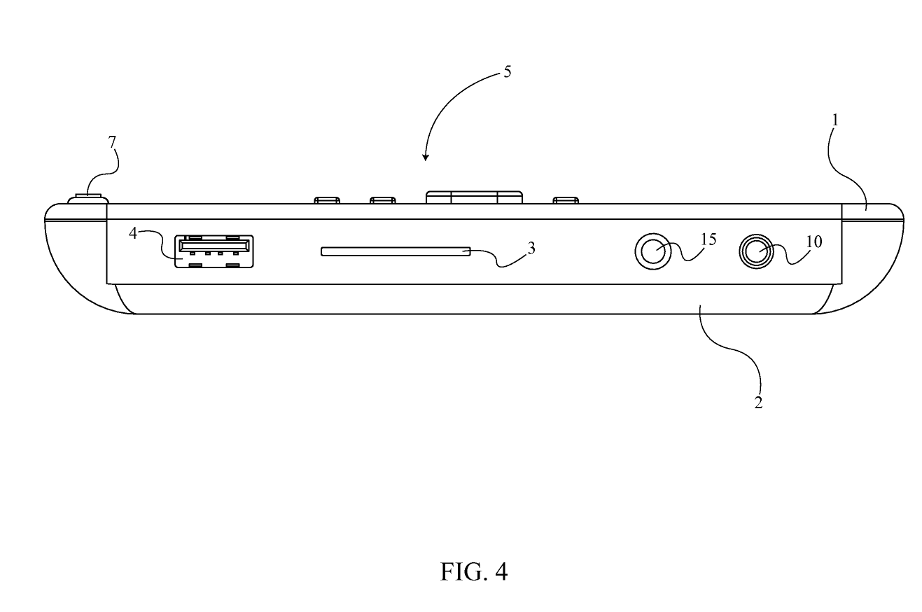

The configuration of the frame casing 1, the base casing 2, the flash memory card slot 3, the USB port 4, the control panel 5, the auto-stereoscopic display screen 6, the 3D ASIC camera 7, the internet connection module 8, the speaker 9, and the headphone jack 10 on present invention allows the user to properly function as a unit and is shown in FIGS. 2 and 4. The frame casing 1 is positioned to border the auto-stereoscopic display screen 6 and is attached around the perimeter of the auto-stereoscopic display screen 6. The base casing 2 is positioned to attach around the perimeter of the frame casing 1. The 3D ASIC camera 7 is positioned on the frame casing 1 along the length of the frame casing 1 and is positioned adjacent to the auto-stereoscopic display screen 6. The control panel 5 is positioned on the frame casing 1 along the width of the frame casing 1 and is positioned adjacent to the auto-stereoscopic display screen 6. The speaker 9 is located within the combination of the frame casing 1 and the base casing 2 and is positioned adjacent to the auto-stereoscopic display screen 6 along the width of the frame casing 1. The headphone jack 10, the flash memory card slot 3, and the USB port 4 are laterally positioned around the combination of the frame casing 1 and the base casing 2 and traverse into the combination of the frame casing 1 and the base casing 2. The internet connectivity module 8 is located within the combination of the frame casing 1 and the base casing 2.

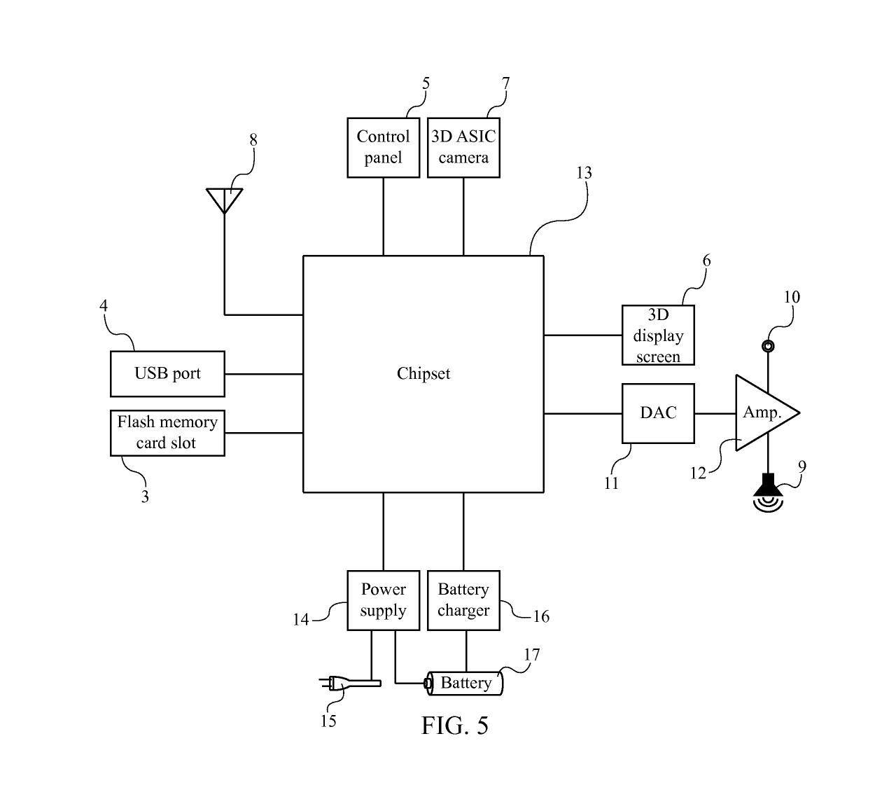

As can be seen in FIG. 5, the internal components of the present invention that allow the present invention to function include a digital-to-analog converter 11 (DAC), an electronic amplifier 12, and a chipset 13. The chipset 13 is a collection of integrated circuits that electronically connect all of the other electronic components of the present invention together. The chipset 13 would most likely include a processor as a means to manage and instruct the other electronic components of the present invention. The chipset 13 is capable of running a software algorithms to enhance the viewing experience of the auto-stereoscopic display screen 6 for the user. The chipset 13 also provides the present invention with a means of internal data storage. Most importantly, the chipset 13 is capable of executing the software that allows the present invention to display, create, and manage the files of stereoscopic electronic media from either the internal data storage of chipset 13, the internet connectivity module 8, the 3D ASIC camera 7, or devices that plug into the flash memory card slot 3 and the USB port 4. In the preferred embodiment of the present invention, the chipset 13 has four gigabytes of internal data storage. Also in the preferred embodiment of the present invention, the chipset 13 is able to support a number of different file formats. The two dimensional video formats would include MKV, MPEG1/2/4, Real Video, Divx and Xvid, M-JPEG, H.264/TS, TP, RM, RMVB, AVI, MPG, MPEG, VOB, DAT, M2TS, MTS and MP4. The three dimensional video formats would include MPO, 3GP, 3DP, and left and right 3D video format. The photo formats would include BMP, JPG, and JPEG. The audio formats would include MP3, MPEG, PCM, AAC WMA, OGG, APE, and WAV.

The DAC 11 and the electronic amplifier 12 allows the present invention to play the audio portion of the stereoscopic electronic media through the speaker 9 or the headphone jack 10. The DAC 11 converts the audio portion of the stereoscopic electronic media from a digital format to an analog format because the speaker 9 or the headphones, which are attached to the headphone jack 10, are analog devices. The electronic amplifier 12 increases the signal strength of the audio portion of the stereoscopic electronic media so that the speaker 9 or the headphones are able to play the audio portion at the proper volume. The DAC 11, the electronic amplifier 12, and the chipset 13 are all located within the combination of the frame casing 1 and the base casing 2.

The connections that are made between the electrical components allows the present invention to function properly. The flash memory card slot 3, the USB port 4, and the internet connection module 8 each electronically connect into the chipset 13. The control panel 5 also electronically connected into the chipset 13. The chipset 13 is electronically connected to the auto-stereoscopic display screen 6 and is electronically connected to the 3D ASIC camera 7. The chipset 13 is also electronically connected to the DAC 11. The DAC 11 is electronically connected to the electronic amplifier 12, which is electronically connected to both the speaker 9 and the headphone jack 10.

The components that are used to power the other components of the present invention include a power supply 14, an alternating current power cord 15 (AC power cord), a battery charger 16, and a rechargeable battery 17. The power supply 14 provides power to each of the electrical components of the present invention and regulates the amount of power received between the rechargeable battery 17 and the AC power cord 15. The power supply 14 is electronically connected into the chipset 13. The rechargeable battery 17 allows the present invention to be powered by a portable source of direct current. The AC power cord 15 allows the present invention to be power by a source of alternating current from a standard outlet. Both the rechargeable battery 17 and the AC power cord 15 are electrically connected into the power supply 14. When the rechargeable battery 17 runs out of electrical power, the battery charger 16 draws electrical power from the AC power cord 15 and replenishes the rechargeable battery 17. The chipset 13 is electronically connected to the battery charger 16, and the battery charger 16 is electrically connected to the rechargeable battery 17. The power supply 14, the rechargeable battery 17, and the battery charger 16 are all located within the combination of the frame casing 1 and the base casing 2. The AC power cord 15 is laterally positioned around the combination of the frame casing 1 and the base casing 2 and traverses into the combination of the frame casing 1 and the base casing 2.

In another embodiment, the present invention additionally comprises an optical disc drive, a second electronic amplifier, and an analog-to-digital converter (ADC). The optical disc player allows the present invention to access stereoscopic electronic media through an optical disc such as a compact disc (CD), a digital video disc (DVD), or a Blu-ray disc (BD). The optical disc player would be laterally positioned around the combination of the frame casing 1 and the base casing 2 and would traverse into the combination of the frame casing 1 and the base casing 2. The second electronic amplifier is electronically connected to the optical disc player in order to increase the strength of the analog signal coming from the optical disc player. The optical disc player produces the analog signal because the optical disc player is physically reading the optical disc. The second electronic amplifier is also electronically connected to the chipset 13 through the ADC, which converts the signal format from analog to digital so that the chipset is able to properly process the signal.

Although the invention has been explained in relation to its preferred embodiment, it is to be understood that many other possible modifications and variations can be made without departing from the spirit and scope of the invention as hereinafter claimed.

What is claimed is:

1. A portable auto-stereoscopic media displaying and recording device comprises,
a frame casing;
a base casing;
a flash memory card slot;
a universal serial bus port (USB port);
a control panel;
an auto-stereoscopic display screen;
a three dimensional application specific integrated circuit camera (3D ASIC camera);
an internet connectivity module;
a speaker;
a headphone jack;
a digital-to-analog converter (DAC);
an electronic amplifier;
a chipset;
a power supply;
an alternating current power cord (AC power cord);
a battery charger; and
a rechargeable battery.

2. The portable auto-stereoscopic media displaying and recording device as claimed in claim 1 comprises,
said auto-stereoscopic display screen being circumscribed by said frame casing;
said auto-stereoscopic display screen being perimetrically attached to said frame casing; and
said frame casing being perimetrically attached to said base casing.

3. The portable auto-stereoscopic media displaying and recording device as claimed in claim 2 comprises,
said control panel being positioned on said base casing adjacent to said auto-stereoscopic display screen;
said speaker being positioned adjacent to said auto-stereoscopic display screen;
said 3D ASIC camera being positioned on said base casing adjacent to said auto stereoscopic display screen;
said flash memory card slot, said USB port, said headphone jack, and said AC power cord being laterally positioned around said frame casing and said base casing; and
said flash memory card slot, said USB port, said headphone jack, and said AC power cord traversing into said frame casing and said base casing.

4. The portable auto-stereoscopic media displaying and recording device as claimed in claim 2 comprises,
said internet connection module, said speaker, said DAC, said electronic amplifier, said chipset, said power supply, said battery charger, and said rechargeable battery being located in between said frame casing and said base casing.

5. The portable auto-stereoscopic media displaying and recording device as claimed in claim 1 comprises,
said 3D ASIC camera being electronically connected to said chipset;
said control panel being electronically connected to said chipset;
said flash memory card slot being electronically connected to said chipset;
said USB port being electronically connected to said chipset; and
said internet connectivity module being electronically connected to said chipset.

6. The portable auto-stereoscopic media displaying and recording device as claimed in claim 1 comprises,
said chipset being electronically connected said DAC;
said DAC being electronically connected to said electronic amplifier;
said electronic amplifier being electronically connected to said speaker;
said electronic amplifier being electronically connected to said headphone jack; and
said chipset being electronically connected said auto-stereoscopic display screen.

7. The portable auto-stereoscopic media displaying and recording device as claimed in claim 1 comprises,
said power supply being electronically connected to said chipset;
said AC power cord being electrically connected to said power supply; and
said rechargeable battery being electrically connected to said power supply.

8. The portable auto-stereoscopic media displaying and recording device as claimed in claim 7 comprises,
said chipset being electronically connected to said battery charger; and
said battery charger being electrically connected to said rechargeable battery.

9. A portable auto-stereoscopic media displaying and recording device comprises,
a frame casing;
a base casing;
a flash memory card slot;
a universal serial bus port (USB port);
a control panel;
an auto-stereoscopic display screen;
a three dimensional application specific integrated circuit camera (3D ASIC camera);
an internet connectivity module;
a speaker;
a headphone jack;
a digital-to-analog converter (DAC);
an electronic amplifier;
a chipset;
a power supply;
an alternating current power cord (AC power cord);
a battery charger;
a rechargeable battery;
said auto-stereoscopic display screen being circumscribed by said frame casing;
said auto-stereoscopic display screen being perimetrically attached to said frame casing;
said frame casing being perimetrically attached to said base casing;
said control panel being positioned on said base casing adjacent to said auto-stereoscopic display screen;
said speaker being positioned adjacent to said auto-stereoscopic display screen;
said 3D ASIC camera being positioned on said base casing adjacent to said auto stereoscopic display screen;
said flash memory card slot, said USB port, said headphone jack, and said AC power cord being laterally positioned around said frame casing and said base casing; and
said flash memory card slot, said USB port, said headphone jack, and said AC power cord traversing into said frame casing and said base casing.

10. The portable auto-stereoscopic media displaying and recording device as claimed in claim 9 comprises,
said internet connection module, said speaker, said DAC, said electronic amplifier, said chipset, said power supply, said battery charger, and said rechargeable battery being located in between said frame casing and said base casing.

11. The portable auto-stereoscopic media displaying and recording device as claimed in claim 9 comprises,
said 3D ASIC camera being electronically connected to said chipset;
said control panel being electronically connected to said chipset;
said flash memory card slot being electronically connected to said chipset;
said USB port being electronically connected to said chipset;
said internet connectivity module being electronically connected to said chipset;
said chipset being electronically connected said DAC;
said DAC being electronically connected to said electronic amplifier;
said electronic amplifier being electronically connected to said speaker;
said electronic amplifier being electronically connected to said headphone jack; and
said chipset being electronically connected said auto-stereoscopic display screen.

12. The portable auto-stereoscopic media displaying and recording device as claimed in claim 9 comprises,
said power supply being electronically connected to said chipset;
said AC power cord being electrically connected to said power supply;
said rechargeable battery being electrically connected to said power supply;
said chipset being electronically connected to said battery charger; and
said battery charger being electrically connected to said rechargeable battery.

13. A portable auto-stereoscopic media displaying and recording device comprises,
a frame casing;
a base casing;
a flash memory card slot;
a universal serial bus port (USB port);
a control panel;
an auto-stereoscopic display screen;
a three dimensional application specific integrated circuit camera (3D ASIC camera);
an internet connectivity module;
a speaker;
a headphone jack;
a digital-to-analog converter (DAC);
an electronic amplifier;
a chipset;
a power supply;
an alternating current power cord (AC power cord);
a battery charger;
a rechargeable battery;
said auto-stereoscopic display screen being circumscribed by said frame casing;
said auto-stereoscopic display screen being perimetrically attached to said frame casing;
said frame casing being perimetrically attached to said base casing;
said 3D ASIC camera being electronically connected to said chipset;
said control panel being electronically connected to said chipset;
said flash memory card slot being electronically connected to said chipset;
said USB port being electronically connected to said chipset;
said internet connectivity module being electronically connected to said chipset;
said chipset being electronically connected said DAC;
said DAC being electronically connected to said electronic amplifier;
said electronic amplifier being electronically connected to said speaker;
said electronic amplifier being electronically connected to said headphone jack; and
said chipset being electronically connected said auto-stereoscopic display screen.

14. The portable auto-stereoscopic media displaying and recording device as claimed in claim 13 comprises,
said control panel being positioned on said base casing adjacent to said auto-stereoscopic display screen;
said speaker being positioned adjacent to said auto-stereoscopic display screen;
said 3D ASIC camera being positioned on said base casing adjacent to said auto stereoscopic display screen;
said flash memory card slot, said USB port, said headphone jack, and said AC power cord being laterally positioned around said frame casing and said base casing;
said flash memory card slot, said USB port, said headphone jack, and said AC power cord traversing into said frame casing and said base casing; and
said internet connection module, said speaker, said DAC, said electronic amplifier, said chipset, said power supply, said battery charger, and said rechargeable battery being located in between said frame casing and said base casing.

15. The portable auto-stereoscopic media displaying and recording device as claimed in claim 13 comprises,
said power supply being electronically connected to said chipset;
said AC power cord being electrically connected to said power supply;
said rechargeable battery being electrically connected to said power supply;
said chipset being electronically connected to said battery charger; and
said battery charger being electrically connected to said rechargeable battery.
